(19) United States
(12) Patent Application Publication
(10) Pub. No.: US 2007/0103905 A1
(43) Pub. Date: May 10, 2007

(54) Light emitting apparatus and control method thereof

(75) Inventors: Jeong-il Kang, Yongin-si (KR); Sang-hoon Lee, Nam-gu (KR); Yung-jun Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/589,809

(22) Filed: Oct. 31, 2006

(30) Foreign Application Priority Data
Nov. 8, 2005 (KR) 2005-0106459

(51) Int. Cl. F21V 23/04

(52) U.S. Cl. 362/276

(57) ABSTRACT

An apparatus and method for controlling emission of light are provided. The light emitting apparatus comprises a plurality of first light emitting parts which are connected with each other in series, a first current supply which supplies a current to the plurality of first light emitting parts, a plurality of switches which are respectively connected with the plurality of first light emitting parts in parallel to make the current be transmitted to or bypass the first light emitting parts and a controller which receives brightness information corresponding to the respective first light emitting parts and controls the plurality of first switches to make overall light emitting time of the first light emitting parts within time intervals correspond to a brightness level of the brightness information. The present invention provides an apparatus and method for emitting light by driving a plurality of light emitting parts to independently emit light in various brightness levels with a simplified circuit configuration and improved efficiency.

### CROSS-REFERENCE TO RELATED APPLICATIONS

This application claims the benefit under 35 U.S.C. §119(a) of Korean Patent Application No. 2005-0106459, filed on Nov. 8, 2005, in the Korean Intellectual Property Office, the entire disclosure of which is hereby incorporated by reference.

### BACKGROUND OF THE INVENTION

1. Field of the Invention

The present invention relates to a light emitting apparatus and a control method thereof. More particularly, the present invention relates to a light emitting apparatus which controls a plurality of LEDs.

2. Description of the Related Art

Generally, a light emitting apparatus comprises a plurality of light emitting parts such as an LED array arranged in a matrix pattern and a display part such as a liquid crystal display (LCD) panel. The plurality of light emitting parts function as a light source to display a predetermined image on the display part.

FIGS. 1a and 1b illustrate an example of a conventional light emitting apparatus. As shown in FIG. 1a, a light emitting apparatus 1a comprises nine LEDs 10a to 10c, 20a to 20c, and 30a to 30c and driving circuits 11a to 11c, 21a to 21c and 31a to 31c which respectively control the nine LEDs 10a to 10C, 20a to 20c and 30a to 30c. The light emitting apparatus 1a may sequentially control a brightness level of the nine LEDs 10a to 10c, 20a to 20c and 30c to 30c through the driving circuits 11a to 11c, 21a to 21c and 31a to 31c. The nine LEDs 10a to 10c, 20a to 20c, and 30a to 30c may comprise a single color or various colors through a mixture of certain colors of the LEDs.

As the driving circuits 11a to 11c, 21a to 21c and 31a to 31c which are respectively distributed to the nine LEDs 10a to 10c, 20a to 20c, and 30a to 30c receive a signal i1, i4, i7; i2, i5, i8 and i3, i6, i9 respectively, the light emitting apparatus 1a may drive the respective LEDs 10a to 10c, 20a to 20c and 30a to 30c to emit light in a certain brightness level or to realize a desired image.

However, with this configuration, the greater the number of the LEDs, the greater the number of the driving circuits and the driving signals. When the LEDs are arranged in the same density, the number of driving circuits and driving signals increases in proportion to a square of an area, thereby causing impracticability.

As shown in FIG. 1b, a light emitting apparatus 1b comprises nine LEDs 12a to 12c, 22a to 22c and 32a to 32c which are arranged in three columns and three rows, three driving circuits 13a to 13c which control respective columns of the nine LEDs 12a to 12c, 22a to 22c and 32a to 32c and three switches 14, 24 and 34 which control respective rows of the nine LEDs 12a to 12c, 22a to 22c and 32a to 32c.

The light emitting apparatus 1b sequentially turns on the three switches 14, 24 and 34 at predetermined time intervals, and supplies a driving current i1, i2 and i3 corresponding to the respective LEDs 12a to 12c, 22a to 22c and 32a to 32c which are disposed in the turned-on row to emit light. After the LEDs 32a to 32c in the last row emit light, the light emitting apparatus 1b drives the LEDs 12a to 12c in the first row to emit light again. When the LEDs in the respective rows are sequentially driven at a fast speed, the human eye does not recognize the change of the light, but recognizes average brightness of the changing light (hereinafter, referred to as “brightness”). Thus, a user may feel that the respective LEDs are simultaneously driven in different brightness.

With this configuration, the number of driving circuits and driving signals corresponds to the number of rows of LEDs, thereby simplifying a circuit configuration. However, there is only one row of LEDs that continuously emit light, thereby lowering the efficiency of the LEDs. The human eye recognizes at best the brightness of the LEDs which is divided by the number of rows. To overcome such a disadvantage, switches may be provided in pairs or in groups, thereby simultaneously driving the LEDs in the rows included in the respective groups. However, in this case, the number of driving circuits and driving signals increases as the number of the groups increases.

Accordingly, there is a need for an improved light emitting apparatus having a simplified circuit configuration and improved efficiency that can drive light emitting parts to independently emit light at various brightness levels.

### SUMMARY OF THE INVENTION

Exemplary embodiments of the present invention address at least the above problems and/or disadvantages and provide at least the advantages described below. Accordingly, it is an exemplary aspect of the present invention to provide a light emitting apparatus which drives a plurality of light emitting parts to independently emit light in various brightness levels with a simplified circuit configuration and improved efficiency, and a control method thereof.

Additional exemplary aspects and/or advantages of the present invention will be set forth in part in the description which follows and, in part, will be obvious from the description, or may be learned by practice of the present invention.

The foregoing and/or other exemplary aspects of the present invention are also achieved by providing a light emitting apparatus, the apparatus comprising a plurality of first light emitting parts which are connected with each other in series, a first current supply which supplies a current to the plurality of first light emitting parts, a plurality of switches which are respectively connected with the plurality of first light emitting parts in parallel to make the current be transmitted to or bypass the first light emitting parts and a controller which receives brightness information corresponding to the respective first light emitting parts and controls the plurality of first switches to make overall light emitting time of the first light emitting parts within time intervals correspond to a brightness level of the brightness information.

According to an exemplary embodiment of the present invention, the first switch comprises a first bypass transistor which is connected with the first light emitting parts in parallel to make the current bypass the first light emitting parts, when turned on.

According to an exemplary embodiment of the present invention, the apparatus further comprises a plurality of second light emitting parts which are connected with each other in series, a second current supply which supplies a current to the plurality of second light emitting parts and a plurality of second switches which are respectively connected with the plurality of second light emitting parts in parallel and make the current be transmitted to or bypass the second light emitting parts, and the controller receives brightness information corresponding to the respective second light emitting parts and controls the plurality of second switches to make overall light emitting time of the second light emitting parts within the time intervals correspond to a brightness level of the brightness information.

According to an exemplary embodiment of the present invention, the second switch comprises a second bypass transistor which is connected with the second light emitting part in parallel to make the current bypass the second light emitting part, when turned on.

According to an exemplary embodiment of the present invention, the first switch further comprises a first memory capacitor which is connected with the first bypass transistor and is charged with a voltage, and the second switch further comprises a second memory capacitor which is connected with the second bypass transistor and is charged with a voltage.

According to an exemplary embodiment of the present invention, the apparatus further comprises a first voltage supply which supplies a turn-on voltage to the first bypass transistor and the second bypass transistor and a plurality of column switch transistors which connect first ends of the plurality of first memory capacitors and first ends of the plurality of second memory capacitors, with one of the first voltage supply and the ground, and the controller controls the plurality of column switch transistors to be independently switched on and off based on the respective brightness information of the plurality of first and second light emitting parts.

According to an exemplary embodiment of the present invention, the apparatus further comprises a current switch transistor which allows the first current supply and the second current supply to supply a current, when turned on, and the controller turns on the current switch transistor when the plurality of first and second memory capacitors are fully charged.

According to an exemplary embodiment of the present invention, the apparatus further comprises a second voltage supply which supplies a voltage which is higher than the turn-on voltage of the first bypass transistor and the second bypass transistor, a first row switch transistor which connects second ends of the plurality of first memory capacitors, with one of the second voltage supply and the ground and a second row switch transistor which connects second ends of the plurality of second memory capacitors, with one of the second voltage supply and the ground, and the controller controls the first row switch transistor to be switched to connect the second ends of the plurality of first memory capacitors to the ground and the second row switch transistor to be switched to connect the second ends of the plurality of second memory capacitors to the second voltage supply, when the plurality of first memory capacitors are charged with a voltage.

According to an exemplary embodiment of the present invention, at least one of the plurality of first switches further comprises a first pull-down transistor which connects the second ends of the first memory capacitors with the first row switch transistor, when turned on, and at least one of the plurality of second switches further comprises a second pull-down transistor which connects the second ends of the second memory capacitors with the second row switch transistor, when turned on, and the apparatus further comprises a third voltage supply which supplies a turn-on voltage to the first pull-down transistor and the second pull-down transistor and a pull-down switch transistor which connects the first and second pull-down transistors with the third voltage supply, when turned on, and the controller turns on the pull-down switch transistor when the plurality of first and second memory capacitors are charged with a voltage, and turns off the pull-down switch transistor when the first current supply and the second current supply a current to the plurality of first and second light emitting parts.

According to an exemplary embodiment of the present invention, the first switch further comprises a first diode which has an anode connected to the first end of the first memory capacitor and a cathode connected to the column switch transistor and a first reset transistor which is connected with the first diode in parallel to make a reverse direction current of the first diode bypass, and the second switch further comprises a second diode which has an anode connected to the first end of the second memory capacitor and a cathode connected to the column switch transistor and a second reset transistor which is connected with the second diode in parallel to make a reverse direction current of the second diode bypass, and the apparatus further comprises a fourth voltage supply which supplies a turn-on voltage to the first and second reset transistors and a reset switch transistor which connects the plurality of first and second reset transistors, with the fourth voltage supply when turned on, and the controller turns on the reset switch transistor after turning off the current switch transistor.

According to an exemplary embodiment of the present invention, the apparatus further comprises a plurality of second light emitting parts which are connected with each other in series, a second current supply which supplies a current to the plurality of second light emitting parts, and a plurality of second switches which are respectively connected with the plurality of second light emitting parts in parallel and make the current be supplied to or bypass the second light emitting parts, and the controller receives brightness information corresponding to the respective second light emitting parts and controls the plurality of second switches to make overall light emitting time of the second light emitting parts within the time intervals correspond to a brightness level of the brightness information.

According to an exemplary embodiment of the present invention, the second switch comprises a second bypass transistor which is connected with the second light emitting part in parallel to make the current bypass the second light emitting part, when turned on.

According to an exemplary embodiment of the present invention, the plurality of first and second light emitting parts comprises a light emitting diode (LED), respectively.

The foregoing and/or other exemplary aspects of the present invention are also achieved by providing a method of controlling a light emitting apparatus which has a plurality of first light emitting parts, the method comprising receiving brightness information corresponding to the plurality of first light emitting parts connected with each other in series, supplying a current to the plurality of first light emitting parts and allowing a current to transmit to the first light emitting parts or allowing a current to bypass the first light emitting parts to make the overall light emitting time of the first light emitting parts within time intervals correspond to a brightness level of the brightness information.

According to an exemplary embodiment of the present invention, the light emitting apparatus further comprises a plurality of second light emitting parts, and the method further comprises receiving brightness information corresponding to the plurality of second light emitting parts connected with each other in series, supplying a current to the plurality of second light emitting parts and allowing a current to transmit to the second light emitting parts or allowing a current to bypass the second light emitting parts to make the overall light emitting time of the second light emitting parts within time intervals correspond to a brightness level of the brightness information.

According to an exemplary embodiment of the present invention, the method further comprises storing control information related to a current transmission of the plurality of first and second light emitting parts independently based on the brightness information.

According to an exemplary embodiment of the present invention, the storing the control information comprises storing the control information of the plurality of first light emitting parts and the plurality of second light emitting parts, sequentially.

According to an exemplary embodiment of the present invention, the supplying the current comprises supplying the current to the plurality of first and second light emitting parts when the control information of the plurality of first and second light emitting parts is completely stored.

According to an exemplary embodiment of the present invention, the method further comprises cutting off a current supply to the plurality of first and second light emitting parts and removing the stored control information of the plurality of first and second light emitting parts.

### BRIEF DESCRIPTION OF THE DRAWINGS

The above and/or other aspects and advantages of the present invention will become apparent and more readily appreciated from the following description of exemplary embodiments, taken in conjunction with the accompanying drawings of which:

FIGS. 1a and 1b illustrate examples of a conventional light emitting apparatus;

FIG. 2 illustrates a configuration of a light emitting apparatus according to an exemplary embodiment of the present invention;

FIG. 3 illustrates a circuit configuration of the light emitting apparatus according to an exemplary embodiment of the present invention;

FIG. 4 illustrates a waveform of an operation of a controller according to an exemplary embodiment of the present invention;

FIG. 5 illustrates the relation between light emitting time of a light emitting part and brightness according to an exemplary embodiment of the present invention; and

FIG. 6 is a control flowchart of a light emitting apparatus according to an exemplary embodiment of the present invention.

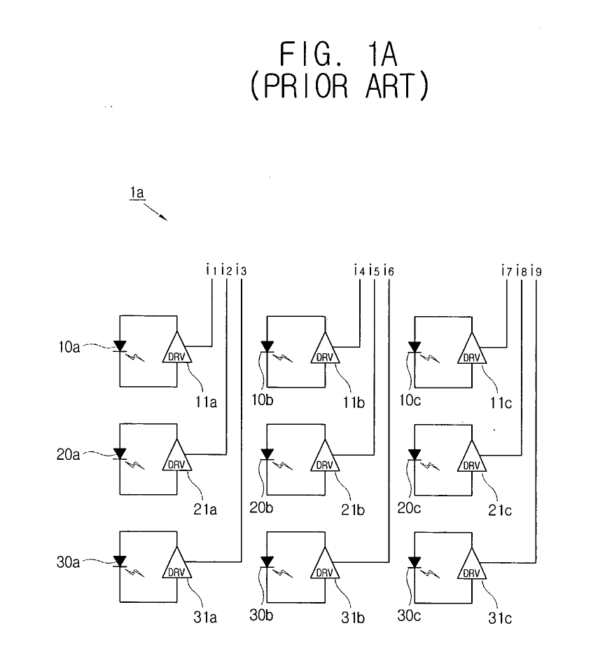

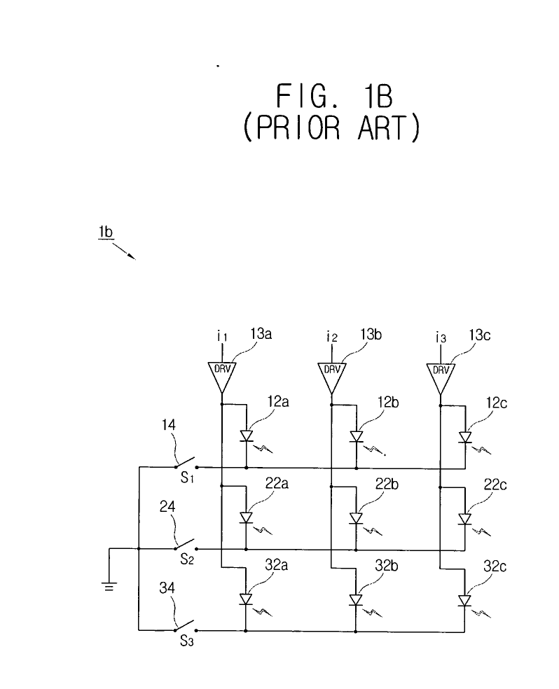

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Reference will now be made in detail to exemplary embodiments of the present invention which are illustrated in the accompanying drawings.

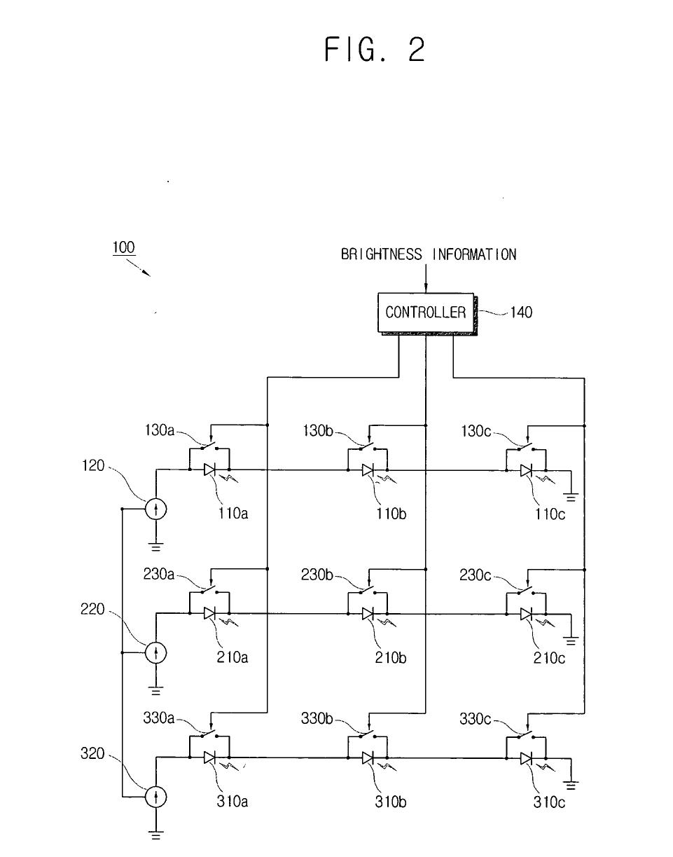

FIG. 2 illustrates a configuration of a light emitting apparatus 100 according to an exemplary embodiment of the present invention. As shown therein, the light emitting apparatus 100 according to an exemplary embodiment of the present invention comprises nine light emitting parts 110a to 110c, 210a to 210c and 310a to 310c which are arranged in three columns and three rows, three current supplies 120, 220 and 320 which supply a current to the respective rows of the nine light emitting parts 110a to 110c, 210a to 210c and 310a to 310c, nine switches 130a to 130c, 230a to 230c and 330a to 330c which are connected with the nine light emitting parts 110a to 110c, 210a to 210c and 310a to 310c in parallel, and switched on and off to supply or cut off the current with respect thereto and a controller 140 which controls the switches 130a to 130c, 230a to 230c and 330a to 330c to receive brightness information corresponding to the plurality of light emitting parts 110a to 110c, 210a to 210c and 310a to 310c and to make an overall light emitting time of the light emitting parts 110a to 110c, 210a to 210c and 310a to 310c correspond to a brightness level of the brightness information within certain time intervals.

Among the nine light emitting parts 110a to 110c, 210a to 210c and 310a to 310c, the light emitting parts 110a to 110c in a first row, the light emitting parts 210a to 210c in a second row and the light emitting parts 310a to 310c in a third row are referred to as first light emitting parts, second light emitting parts and third light emitting parts, respectively. The respective light emitting parts 110a to 110c, 210a to 210c and 310a to 310c may comprise light emitting diodes (LEDs). The light emitting parts 110a to 110c, 210a to 210c and 310a to 310c of the respective rows are connected with each other in series.

Among the nine switches 130a to 130c, 230a to 230c and 330a to 330c, the switches 130a to 130c in a first row, the switches 230a to 230c in a second row and the switches 330a to 330c in a third row are referred to as first switches, second switches and third switches, respectively. Among the three current supplies 120, 220 and 320, the current supply 120 in a first row, the current supply 220 in a second row and the current supply 320 in a third row are referred to as a first current supply, a second current supply and a third current supply.

The controller 140 controls a time ratio of turning on and off the switches 130a to 130c, 230a to 230c and 330a to 330c, thereby driving the light emitting parts 110a to 110c, 210a to 210c and 310a to 310c to emit light in various gradations and brightness levels as the human eye recognizes the brightness levels of the respective light emitting parts 110a to 110c, 210a to 210c and 310a to 310c differently. The plurality of light emitting parts 110a to 110c, 210a to 210c and 310a to 310c according to an exemplary embodiment of the present invention are shaped like a matrix but are not limited thereto. The plurality of light emitting parts 110a to 110c, 210a to 210c and 310a to 310c may be provided in various shapes. The colors of the respective light emitting parts 110a to 110c, 210a to 210c and 310a to 310c are not limited.

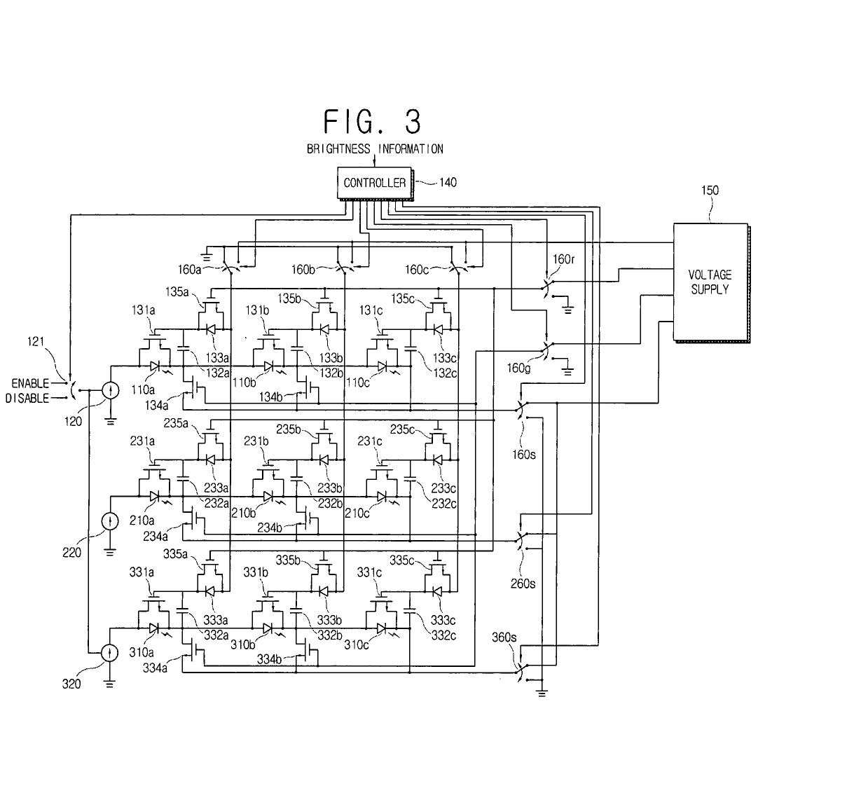

FIG. 3 illustrates a configuration of the light emitting apparatus 100 according to an exemplary embodiment of the present invention. The respective first switches 130a to 130c of the light emitting apparatus 100 are connected with the first light emitting parts 110a to 110c in parallel. The first switches 130a to 130c of the light emitting apparatus 100 comprise first bypass transistors 131a to 131c which are connected with the first light emitting parts 110a to 110c in parallel, and make the current bypass the first light emitting parts 110a to 110c, when turned on. The first bypass transistors 131a to 131c may be realized as a Field Effect Transistor (FET), and the like. When implemented as a FET, a drain electrode and a source electrode of each of the first bypass transistors 131a to 131c are connected with opposite ends of the concerned first light emitting part 110a, 110b or 110c.

Also, the second switches 230a to 230c and the third switches 330a to 330c comprise second bypass transistors 231a to 231c and third bypass transistors 331a to 331c, respectively. The configuration of the second and third switches 230a to 230c and 330a to 330c is the same as that of the first switches 130a to 130c, other than the additional description.

The first switches 130a to 130c further comprise first memory capacitors 132a to 132c, respectively, which may be charged with a voltage. A first end of the first memory capacitors 132a, 132b or 132c is connected with a gate electrode of the corresponding first bypass transistor 131a, 131b or 131c, and a second end thereof is connected with the source electrode of the corresponding first bypass transistor 131a, 131b or 131c.

Also, the second switches 230a to 230c and the third switches 330a to 330c comprise second memory capacitors 232a to 232c and third memory capacitors 332a to 332c, respectively.

The light emitting apparatus 100 further comprises a voltage supply 150 which supplies a turn-on voltage Va to the first bypass transistors 131a to 131c, the second bypass transistors 231a to 231c and the third bypass transistors 331a to 331c. The light emitting apparatus 100 also comprises three column switch transistors 160a to 160c which connect the first end of each first memory capacitors 132a, 132b or 132c, each second memory capacitors 232a, 232b or 232c, and each third memory capacitors 332a, 332b or 332c, to an output terminal supplying the turn-on voltage Va or to ground.

When the turn-on voltage Va is supplied to the gate electrode and the source electrode of the first bypass transistors 131a, 131b or 131c, the second bypass transistors 231a, 231b or 231c or the third bypass transistors 331a, 331b or 331c, a current flows between the drain electrode and the source electrode of the corresponding bypass transistor. The current supplied to the corresponding light emitting part of the light emitting parts 110a, 110b, 110c, 210a, 210b, 210c, 310a, 310b and 310c bypasses through the first bypass transistor 131a, 131b or 131c, the second bypass transistor 231a, 231b or 231c or the third bypass transistor 331a, 331b or 331c. The column switch transistors 160a to 160c may be realized as a FET, and the like.

The voltage supply 150 supplies a voltage Vs which is higher than the turn-on voltage Va, to the first bypass transistors 131a to 131c, the second bypass transistors 231a to 231c and the third bypass transistors 331a to 331c.

The light emitting apparatus 100 further comprises a first row switch transistor 160s which connects the second end of the first memory capacitors 132a to 132c with one of the output terminal of the voltage Vs of the voltage supply 150 or ground, with respect to the first light emitting parts 110a to 110c. The light emitting apparatus 100 further comprises a second row switch transistor 260s and a third row switch transistor 360s, with respect to the second light emitting parts 210a to 210c and the third light emitting parts 310a to 310c.

The first switches 130a and 130b further comprise first pull down transistors 134a and 134b, respectively, which are disposed between the second end of the first memory capacitors 132a and 132b, and the first row switch transistor 160s to connect them, when turned on. The second switches 230a and 230b and the third switches 330a and 330b further comprise second pull down transistors 234a and 234b and third pull down transistors 334a and 334b, respectively. The first pull down transistors 134a and 134b, the second pull down transistors 234a and 234b and the third pull down transistors 334a and 334b may each be realized as a FET, and the like.

The voltage supply 150 supplies a turn-on voltage Vg to the first pull down transistors 134a and 134b, the second pull down transistors 234a and 234b and the third pull down transistors 334a and 334b. The light emitting apparatus 100 further comprises a pull down switch transistor 160g which is disposed between the first pull down transistors 134a and 134b, the second pull down transistors 234a and 234b and the third pull down transistors 334a and 334b, and an output terminal supplying the turn-on voltage Vg of the voltage supply 150, to connect them when tuned on.

The respective first switches 130a to 130c further comprise a first diode 133a 133b and 133c which has an anode connected to the first end of the first memory capacitor 132a, 132b and 132c and a cathode connected to the column switch transistor 160a, 160b and 160c. The respective first switches 130a to 130c also comprise a first reset transistor 135a, 135b and 135c which is connected with the first diode 133a 133b and 133c in parallel to allow a reverse current of the first diode 133a, 133b and 133c to bypass, when turned on. The second switches 230a to 230c and the third switches 330a to 330c further comprise second reset transistors 235a to 235c and third reset transistors 335a to 335c, respectively.

The voltage supply 150 supplies a turn-on voltage Vr to the first reset transistors 135a to 135c, the second reset transistors 235a to 235c and the third reset transistors 335a to 335c. The light emitting apparatus 100 further comprises a reset switch transistor 160r which is disposed between the first reset transistors 135a to 135c, the second reset transistors 235a to 235c and the third reset transistors 335a to 335c, and the voltage supply 150, to connect them, when turned on. The voltage supply 150 is merely an exemplary embodiment of the present invention. In another exemplary embodiment, the voltages may be supplied by each of a first voltage supply, a second voltage supply, a third voltage supply and a fourth voltage supply.

The light emitting apparatus 100 further comprises a current switch transistor 121 which allows the first current supply 120, the second current supply 220 and the third current supply 320 to supply a current when turned on and cuts off the current when turned off.

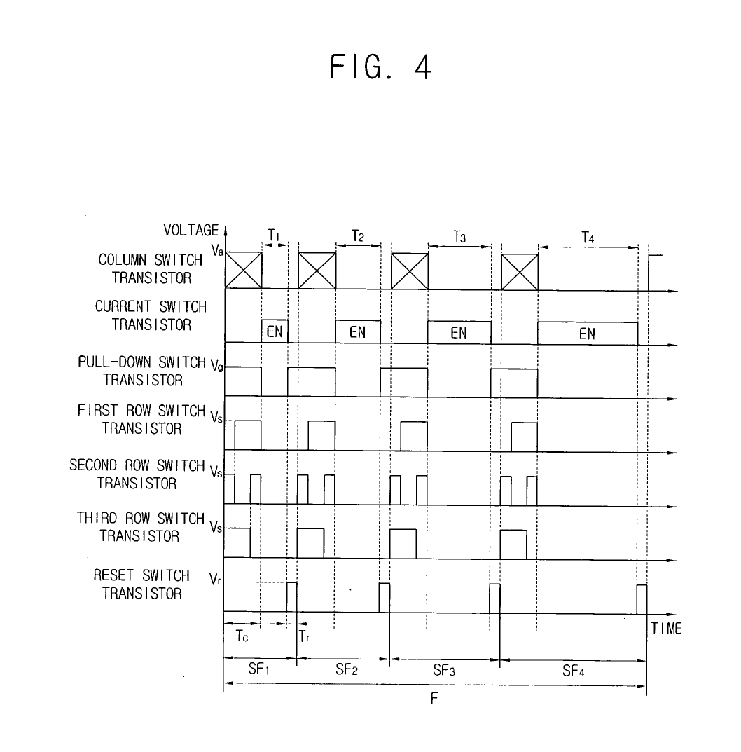

FIG. 4 illustrates a waveform of an operation of the controller 140 according to an exemplary embodiment of the present invention. The controller 140 operates using a main frame F as a time interval. The main frame F according to an exemplary embodiment of the present invention comprises 4 sub frames SF1 to SF4 of different time intervals. The controller 140 controls the first memory capacitors 132a to 132c, the second memory capacitors 232a to 232c and the third memory capacitors 332a to 332c to be charged and discharged, and controls the first light emitting parts 110a to 110c, the second light emitting parts 210a to 210c and the third light emitting parts 310a to 310c to emit light, within the respective sub frames SF1 to SF4.

That is, each of the respective sub frames SF1 to SF4 comprise a charging time Tc and a discharging time Tr of the first memory capacitors 132a to 132c, the second memory capacitors 232a to 232c and the third memory capacitors 332a to 332c. The respective sub frames SF1 to SF4 further comprise light emitting times T1 to T4 of the first light emitting parts 110a to 110c, the second light emitting parts 210a to 210c and the third light emitting parts 310a to 310c.

At an initializing stage of the light emitting apparatus 100, the controller 140 discharges the first memory capacitors 132a to 132c, the second memory capacitors 232a to 232c and the third memory capacitors 332a to 332c, to a zero voltage or ground, and turns off the current switch transistor 121 and the reset switch transistor 160r.

The controller 140 turns on the pull down switch transistor 160g when the first memory capacitors 132a to 132c, the second memory capacitors 232a to 232c and the third memory capacitors 332a to 332c are charged with a voltage. Thus, the turn-on voltage Vg of the voltage supply 150 is supplied to the first pull down transistors 134a and 134b, the second pull down transistors 234a and 234b and the third pull down transistors 334a and 334b to be turned on.

When a voltage is to be charged to the first memory capacitors 132a to 132c, the controller 140 controls the first row switch transistor 160s, the second row switch transistor 260s and the third row switch transistor 360s to be switched on and off to connect the second end of the first memory capacitors 132a to 132c to the ground, and to connect the second end of the second memory capacitors 232a to 232c and the third memory capacitors 332a to 332c to an output terminal of the voltage Vs of the voltage supply 150. As the second end of the first memory capacitors 132a to 132c is connected to the ground, the first memory capacitors 132a to 132c are charged with the voltage Va supplied to a first end thereof. Meanwhile, the voltage Vs supplied to the second end of the second memory capacitors 232a to 232c and the third memory capacitors 332a to 332c is higher than the voltage Va supplied to the first end thereof, the second memory capacitors 232a to 232c and the third memory capacitors 332a to 332c are not charged.

When the first memory capacitors 132a to 132c are charged, the controller 140 controls the column switch transistors 160a to 160c to be independently switched on and off based on the input brightness information of the respective first light emitting parts 110a to 110c. Then, the voltage Va or ground voltage is supplied to the first end of the first memory capacitor 132a, 132b or 132c through the first diode 133a, 133b or 133c, thereby charging the first memory capacitor 132a, 132b or 132c. Also, the controller 140 controls the first row switch transistor 160s, the second row switch transistor 260s and the third row switch transistor 360s to be switched on and off to charge the second memory capacitors 232a to 232c and the third memory capacitors 332a to 332c. As a gate voltage of the first bypass transistor 131a, 131b or 131c, the second bypass transistor 231a, 231b or 231c, or the third bypass transistor 331a, 331b or 331c in the row except the charged row, is same or identical with/to the voltage Va, the first diode 133a, 133b or 133c, the second diode 233a, 233b or 233c or the third diode 333a, 333b or 333c is biased in a reverse direction, the charged state of the first memory capacitor 132a, 132b or 132c, the second memory capacitor 232a, 232b or 232c or the third memory capacitor 332a, 332b or 332c is not changed.

When the first memory capacitors 132a to 132c, the second memory capacitors 232a to 232c and the third memory capacitors 332a to 332c are fully charged, the controller 140 turns off the pull down switch transistor 160g to turn off the first pull down transistors 134a and 134b, the second pull down transistors 234a and 234b and the third pull down transistors 334a and 334b. Then, a terminal which is opposite to a terminal through which the current is supplied to the first light emitting part 110c, the second light emitting part 210c and the third light emitting part 310c, and a second end of the first memory capacitor 132c, the second memory capacitor 232c and the third memory capacitor 332c are connected to the ground. The controller 140 turns on the current switch transistor 121 to simultaneously supply the current to the first light emitting parts 110a to 110c, the second light emitting parts 210a to 210c and the third light emitting parts 310a to 310c.

The current bypasses the first light emitting parts 110a to 110c, the second light emitting parts 210a to 210c and the third light emitting parts 310a to 310c through the first bypass transistors 131a to 131c, the second bypass transistors 231a to 231c and the third bypass transistors 331a to 331c, and flows to the first memory capacitors 132a to 132c, the second memory capacitors 232a to 232c and the third memory capacitors 332a to 332c. The first light emitting parts 110a to 110c, the second light emitting parts 210a to 210c and the third light emitting parts 310a to 310c independently emit light corresponding to the brightness information, according to whether the first memory capacitors 132a to 132c, the second memory capacitors 232a to 232c and the third memory capacitors 332a to 332c are charged with the voltage.

When it is determined that the light emitting time T1 has elapsed corresponding to the first sub frame SF1 after the current switch transistor 121 is turned on, the controller 140 turns off the current switch transistor 121 and turns on the pull down switch transistor 160g, thereby turning on the first pull down transistors 134a and 134b, the second pull down transistors 234a and 234b and the third pull down transistors 334a and 334b. Also, the controller 140 turns on the reset switch transistor 160r to turn on the first reset transistors 135a to 135c, the second reset transistors 235a to 235c and the third reset transistors 335a to 335c, and connects the column switch transistors 160a to 160c to ground.

Thus, the voltage charged in the first memory capacitors 132a to 132c, the second memory capacitors 232a to 232c and the third memory capacitors 332a to 332c bypasses through the corresponding first reset transistors 135a to 135c, the second reset transistors 235a to 235c and the third reset transistors 335a to 335c to be discharged to ground.

When the operation in the first sub frame SF1 is completed, the controller 140 sequentially controls operation in the remaining sub frames SF2 to SF4, as described above.

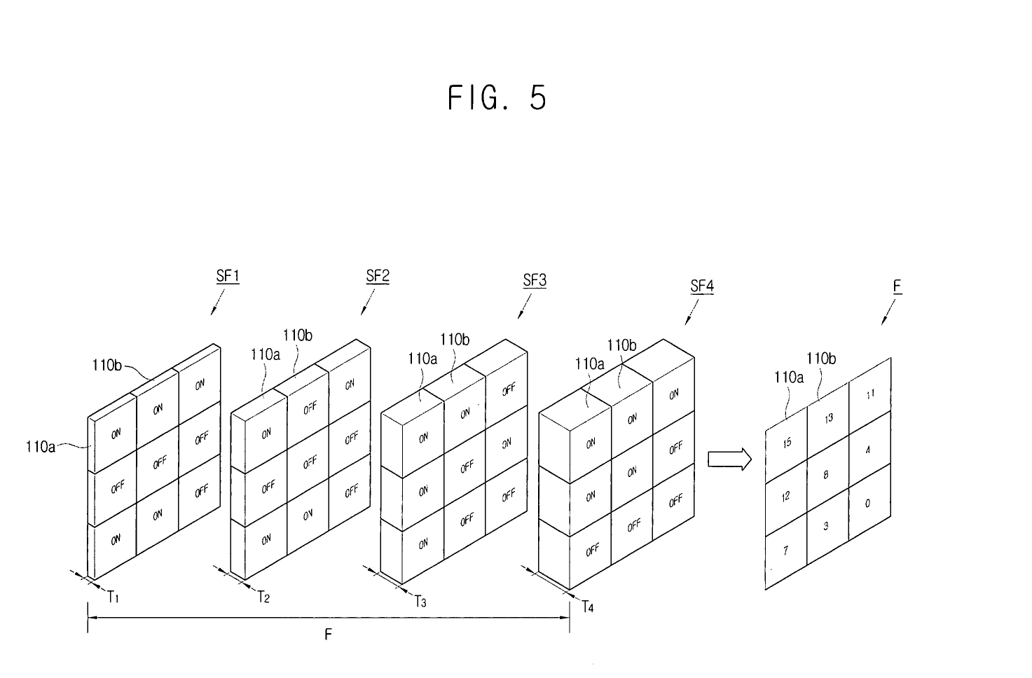

FIG. 5 illustrates the relation between the light emitting time of the light emitting parts 110a to 110c, 210a to 210c and 310a to 310c according to an exemplary embodiment of the present invention, and the brightness levels. When the input brightness information has a level of 2n, the light emitting parts 110a to 110c, 210a to 210c and 310a to 310c realize the brightness in various gradations through sub frames in an N number having charging time ratio of 1:2 . . . :2n. For example, when the brightness information respectively input to the light emitting parts 110a to 110c, 210a to 210c and 310a to 310c has levels of 0-15, the ratio of the light emitting times T1 to T4 of the sub frames SF1 to SF4 may be 1:2:4:8. As shown therein, when the light emitting part 110a emits light in the respective 4 sub frames SF1 to SF4, the average brightness of the light emitting part 110a has a brightness level of 15 (=1+2+4+8). When the light emitting part 110b sequentially emits light in the sub frame SF1, does not emit light in the sub frame SF2, and emits light in the sub frames SF3 and SF4, the average brightness of the light emitting part 110b has a brightness level of 13(1+0+4+8). As the light emitting parts 110a to 110c, 210a to 210c and 310a to 310c independently emit light in the sub frames SF1 to SF4, various levels of brightness can be realized corresponding to the input brightness information.

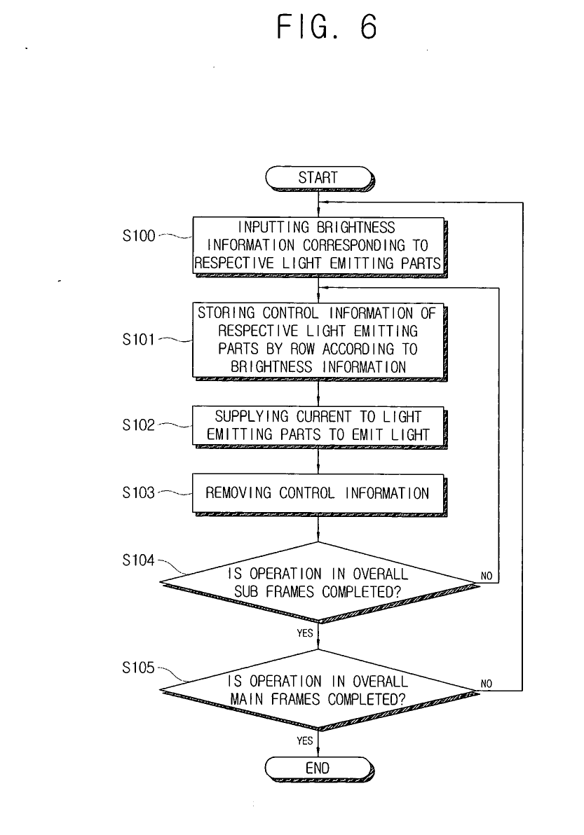

FIG. 6 is a control flowchart of the light emitting apparatus 100 according to an exemplary embodiment of the present invention. The brightness information is input corresponding to the respective light emitting parts 110a to 110c, 210a to 210c and 310a to 310c in the concerned main frame (S100). Control information corresponding to the light emitting parts 110a to 110c, 210a to 210c and 310a to 310c is stored by row according to the input brightness information (S100). The control information comprises information on whether the current is supplied to or bypasses the light emitting parts 110a to 110c, 210a to 210c and 310a to 310c in the concerned sub frames. The control information is set to make the overall light emitting time of the respective light emitting parts 110a to 110c, 210a to 210c and 310a to 310c correspond to the brightness level of the brightness information in the main frame.

When the control information is fully stored with respect to the overall rows in the concerned sub frames, the current is supplied to the light emitting parts 110a to 110c, 210a to 210c and 310a to 310c. As the current is supplied to or bypasses the light emitting parts 110a to 110c, 210a to 210c and 310a to 310c based on the stored control information, the light emitting parts 110a to 110c, 210a to 210c and 310a to 310c independently emit light (S102). As described above, the light emitting time in the concerned sub frames, is set to correspond to the brightness level of the brightness information. When the light emitting parts 110a to 110c, 210a to 210c and 310a to 310c complete the light emitting operation in the concerned sub frames, the stored control information is removed (S103). Then, it is determined whether the operation in the overall sub frames is completed (S104). When it is determined that the operation in the sub frames is not completed, the control information is stored according to the brightness information with respect to the next sub frame (S101).

When it is determined that the operation in the overall sub frames is completed, it is determined whether the operation in the overall main frames is completed (S105). When it is determined that the operation in the overall main frames is not completed, the brightness information corresponding to the concerned main frame is input (S100). When it is determined that the operation in the overall main frames is completed, the operation is completed.

As described above, exemplary embodiments of the present invention provide a light emitting apparatus which drives a plurality of light emitting parts to independently emit light in various brightness levels with a simplified circuit configuration and improved efficiency.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A light emitting apparatus, the apparatus comprising:
a plurality of first light emitting parts which are connected with each other in series;
a first current supply for supplying a first current to the plurality of first light emitting parts;
a plurality of first switches respectively connected in parallel with the plurality of first light emitting parts for selectively bypassing the first current supplied to the first light emitting parts; and
a controller for receiving brightness information corresponding to each of the plurality of first light emitting parts and for controlling the plurality of first switches to make an overall light emitting time of each of the plurality of first light emitting parts within desired time intervals correspond to a brightness level of the brightness information.

2. The apparatus according to claim 1, wherein each of the plurality of first switches comprises a first bypass transistor respectively connected in parallel with the plurality of the first light emitting parts for bypassing the current to the first light emitting parts.

3. The apparatus according to claim 2, further comprising:
a plurality of second light emitting parts which are connected with each other in series;
a second current supply for supplying a second current to the plurality of second light emitting parts; and
a plurality of second switches respectively connected in parallel with the plurality of second light emitting parts for bypassing the second current supplied to the second light emitting parts, wherein
the controller receives brightness information corresponding to each of the plurality of second light emitting parts and for controlling the plurality of second switches to make an overall light emitting time of each of the plurality of second light emitting parts within the desired time intervals correspond to a brightness level of the brightness information.

4. The apparatus according to claim 3, wherein each of the plurality of second switches comprises a second bypass transistor respectively connected in parallel with the plurality of the second light emitting parts for bypassing the current to the second light emitting parts.

5. The apparatus according to claim 4, wherein each of the plurality of first switches further comprise a first memory capacitor connected with the first bypass transistor for charging with a voltage, and wherein
each of the plurality of second switches further comprise a second memory capacitor connected with the second bypass transistor for charging with a voltage.

6. The apparatus according to claim 5, further comprising:
a first voltage supply for supplying a turn-on voltage to each of the plurality of first bypass transistors and each of the plurality of second bypass transistors; and
a plurality of column switch transistors for connecting first ends of the plurality of first memory capacitors and first ends of the plurality of second memory capacitors with one of the first voltage supply and ground, wherein
the controller controls the plurality of column switch transistors to be independently switched on and off based on the respective brightness information of the plurality of first and second light emitting parts.

7. The apparatus according to claim 6, further comprising:
a current switch transistor for controlling the first current supply and the second current supply, wherein
the controller controls the current switch transistor.

8. The apparatus according to claim 7, further comprising:
a second voltage supply for supplying a second voltage which is higher than the turn-on voltage of the first voltage supply;
a first row switch transistor for connecting second ends of the plurality of first memory capacitors with one of the second voltage supply and ground; and
a second row switch transistor for connecting second ends of the plurality of second memory capacitors with one of the second voltage supply and ground, wherein
the controller controls the first row switch transistor to connect the second ends of the plurality of first memory capacitors to ground and the second row switch transistor to connect the second ends of the plurality of second memory capacitors to the second voltage supply.

9. The apparatus according to claim 8, wherein at least one of the plurality of first switches further comprises a first pull-down transistor for connecting the second ends of the first memory capacitors with the first row switch transistor, wherein
at least one of the plurality of second switches further comprises a second pull-down transistor for connecting the second ends of the second memory capacitors with the second row switch transistor, and wherein
the apparatus further comprises:
a third voltage supply for supplying a turn-on voltage to the first pull-down transistor and the second pull-down transistor; and
a pull-down switch transistor for connecting the first and second pull-down transistors with the third voltage supply, wherein
the controller controls the pull-down switch transistor to supply a voltage when the plurality of first and second memory capacitors are charged with a voltage, and controls the pull-down switch transistor to isolate when the first current supply and the second current supply a current to the plurality of first and second light emitting parts.

10. The apparatus according to claim 9, wherein the first switch further comprises:
a first diode comprising an anode connected to the first end of the first memory capacitor and a cathode connected to the column switch transistor; and
a first reset transistor connected in parallel with the first diode for bypassing a reverse current of the first diode, wherein
the second switch further comprises:
a second diode comprising an anode connected to the first end of the second memory capacitor and a cathode connected to the column switch transistor; and
a second reset transistor connected in parallel with the second diode for bypassing a reverse current of the second diode, and wherein
the apparatus further comprises:
a fourth voltage supply for supplying a turn-on voltage to the first and second reset transistors; and
a reset switch transistor connecting the first and second reset transistors with the fourth voltage supply, wherein
the controller controls the reset switch transistor after turning off the current switch transistor.

11. The apparatus according to claim 1, the apparatus further comprising:
a plurality of second light emitting parts connected with each other in series;
a second current supply for supplying a current to the plurality of second light emitting parts; and
a plurality of second switches respectively connected in parallel with the plurality of second light emitting parts for bypassing the second light emitting parts, wherein
the controller receives brightness information corresponding to the respective second light emitting parts and controls the plurality of second switches to make an overall light emitting time of each of the plurality of second light emitting parts within the time intervals correspond to a brightness level of the brightness information.

12. The apparatus according to claim 11, wherein the second switch comprises a second bypass transistor connected in parallel with the second light emitting part for bypassing the current bypass to the second light emitting part.

13. The apparatus according to claim 1, wherein the plurality of first light emitting parts comprises a light emitting diode (LED), respectively.

14. The apparatus according to claim 1, wherein the desired time intervals comprise at least two time intervals and further wherein each of the desired time intervals vary in duration from the other desired time intervals.

15. A method of controlling a light emitting apparatus, the method comprising:
receiving brightness information corresponding to a plurality of first light emitting parts connected with each other in series;
supplying a current to the first light emitting parts or allowing the supplied current to bypass the first light emitting parts to make an overall light emitting time of the first light emitting parts within time intervals correspond to a brightness level of the brightness information.

16. The method according to claim 15, further comprising:
receiving brightness information corresponding to a plurality of second light emitting parts connected with each other in series;
supplying a current to the second light emitting parts or allowing the supplied current to bypass the second light emitting parts to make an overall light emitting time of the second light emitting parts within time intervals correspond to a brightness level of the brightness information.

17. The method according to claim 16, further comprising:
storing control information related to a transmission of the plurality of first and second light emitting parts independently based on the brightness information.

18. The method according to claim 17, wherein the storing the control information comprises storing the control information of the plurality of first light emitting parts and the plurality of second light emitting parts, sequentially.

19. The method according to claim 18, wherein the supplying the current comprises supplying the current to the plurality of first and second light emitting parts when the control information of the plurality of first and second light emitting parts is completely stored.

20. The method according to claim 19, the method further comprising:
stopping a current supply to the plurality of first and second light emitting parts and removing the stored control information of the plurality of first and second light emitting parts.

21. A light emitting apparatus comprising:
a plurality of first light emitting parts;
a plurality of first switches respectively connected in parallel to the plurality of first light emitting parts;
a controller for controlling each of the plurality of first switches based on brightness information.

22. The light emitting apparatus of claim 20, further comprising a current source for supplying current to the plurality of first light emitting parts, wherein the plurality of switches operates to bypass the supplied current based on the brightness information.

23. A light emitting apparatus comprising:
a light emitting part; and
a controller for receiving brightness information and for controlling an output of the light emitting part based on the received brightness information,
wherein the output of the light emitting part is controlled by the controller during an overall light emitting time such that the light emitting part outputs light during selected sub-intervals of the overall light emitting time in relation to the received brightness information.

24. The light emitting apparatus of claim 23, wherein each subinterval has a duration varied from the other subintervals.
